(19) United States
(12) Patent Application Publication
(10) Pub. No.: US 2012/0178842 A1
(43) Pub. Date: Jul. 12, 2012

(54) HALOGEN-FREE, FLAME-PROOF POLYMER FOAMS CONTAINING AT LEAST ONE OLIGOPHOSPHORUS COMPOUND

(75) Inventors: Klaus Hahn, Kirchheim (DE); Olaf Kriha, Frankenthal (DE); Ingo Bellin, Mannheim (DE); Patrick Spies, Neustadt (DE); Sabine Fuchs, Mannheim (DE); Peter Deglmann, Mannheim (DE); Klemens Massonne, Bad Durkheim (DE); Hartmut Denecke, Ludwigshafen (DE); Christoph Fleckenstein, Freigericht (DE); Geert Janssens, Friedelsheim (DE)

(73) Assignee: BASF SE, Ludwigshafen (DE)

(21) Appl. No.: 13/394,348

(22) PCT Filed: Sep. 10, 2010
(86) PCT No.: PCT/EP10/63304

§ 371 Date: Mar. 6, 2012

(30) Foreign Application Priority Data
Sep. 14, 2009 (EP) 09170196.1

(51) Int. Cl. C08K 5/51; D01D 5/40

(52) U.S. Cl. 521/155; 264/140

(57) ABSTRACT

Halogen-free, flame-retardant polymer foams which comprise, as flame retardant, at least one cyclic or acyclic oligophosphorus compound, and processes for their production. Examples of suitable oligophosphorus compounds are those having the structure Ia, Ib, or Ic:

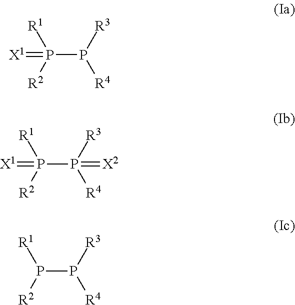

Another group of suitable oligophosphorus compounds is that having one of the following structures IIa, IIb, or IIc:

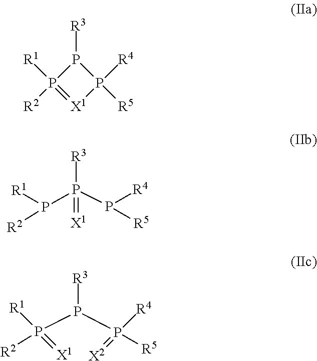

Cyclic oligophosphorus compounds of the following structure III are also suitable:

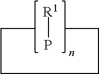

The radicals R¹-R⁵ have been selected independently of one another from the group of C₁-C₁₆-alkyl, C₁-C₁₆-alkenyl, C₁-C₁₆-alkoxy, C₁-C₁₆-alkenyloxy, C₃-C₁₀-cycloalkyl, C₃-C₁₀-cycloalkoxy, C₆-C₁₀-aryl, C₆-C₁₀-aryloxy, C₆-C₁₀-aryl-C₁-C₁₆-alkyl, C₆-C₁₀-aryl-C₁-C₁₆-alkoxy, NR²R³, COR², COOR², and CONR²R³ , and the radicals X¹ and X², independently of one another, are O or S.

The invention relates to halogen-free, flame-retardant polymer foams which comprise, as flame retardant, at least one cyclic or acyclic oligophosphorus compound, and also to processes for their production.

The use of flame retardants to modify polymer foams is important for a wide variety of applications, for example for molded polystyrene foams made of expandable polystyrene (EPS) or extruded polystyrene foam sheets (XPS) for the insulation of buildings. The polystyrene homo- and copolymers here have hitherto mainly used halogen-containing, in particular brominated, organic compounds. However, questions have been raised as to whether many of these brominated substances are potentially hazardous to the environment and to health.

U.S. Pat. No. 4,111,899 describes cyclic or acyclic oligophosphorus compounds having one or more P—P bonds, these being used in amounts of about 1000 ppm for the stabilization of thermoplastics, in particular polycarbonates, when the materials are exposed to heat and/or oxygen during injection molding.

U.S. Pat. No. 6,369,140 describes inter alia cyclic oligophosphines at low concentrations as stabilizers to inhibit degradation of polyolefins by heat, mechanical stress, or light.

WO 2009/030708 describes cyclic and polymeric arylphosphines as flame retardants in various plastics, such as polycarbonates or acrylonitrile-butadiene-styrene copolymers (ABS).

EP-A 834 529 describes expandable styrene polymers which comprise, as halogen-free flame retardant, a mixture of a phosphorus compound and a metal hydroxide that eliminates water. A preferred method incorporates from 5 to 10% by weight of Mg(OH)₂ and from 5 to 10% by weight of triphenyl phosphate (TPP) into molten polystyrene in an extruder, pelletizes the mixture, and post-impregnates the pellets with blowing agent in aqueous suspension.

WO 00/34342 describes a process for the production of expandable polystyrene via suspension polymerization of styrene in the presence of from 5 to 50% by weight of expandable graphite and optionally from 2 to 20% by weight of a phosphorus compound as flame retardant.

WO 2006/027241 discloses the use of 9,10-dihydro-9-oxa-10-phosphaphenanthrene 10-oxide (DOP) and its derivatives for the production of polymer foams rendered flame-retardant by a halogen-free method.

Markedly larger amounts of halogen-free flame retardants generally have to be used to achieve the flame-retardant effect of halogen-containing flame retardants. It is therefore often the case that polymer foams cannot use halogen-free flame retardants that are useful in thermoplastic polymers, such as polystyrene, because they either disrupt the foaming process or affect the mechanical and thermal properties of the polymer foam. A further factor is that when expandable polystyrene is produced via suspension polymerization, the large amounts of flame retardant can reduce the stability of the suspension.

When the flame retardants used for thermoplastic polymers are used in polymer foams, it is often impossible to predict their effect, because of differences in fire behavior and in the fire tests used.

It was therefore an object of the invention to find, for polymer foams, and in particular for expandable polystyrene (EPS) or extruded polystyrene foam sheets (XPS), a halogen-free flame retardant which does not have any substantial effect on the foaming process or on mechanical properties, and which in particular permits the production of mainly closed-cell polymer foams.

The materials accordingly found are halogen-free, flame-retardant polymer foams which comprise, as flame retardant, at least one cyclic or acyclic oligophosphorus compound. Surprisingly, these oligophosphorus compounds exhibit substantially better effectiveness as flame retardants in polymer foams, in comparison with the halogen-free flame retardants usually used for polymer foams.

The phosphorus content of the oligophosphorus compounds is preferably in the range from 5 to 50% by weight, in particular in the range from 8 to 25% by weight. Preferred flame retardants comprise at least one cyclic or acyclic oligophosphine or oligophosphine chalcogenide having from 2 to 6 phosphorus atoms and having at least one phosphorus-phosphorus bond. It is preferable that all of the phosphorus atoms have linear or cyclic linkage to one another via P—P bonds.

Examples of suitable oligophosphorus compounds are those having the structure Ia, Ib, or Ic:

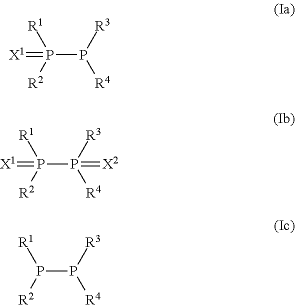

The radicals R¹-R⁴ can have been selected independently of one another from the group of C₁-C₁₆-alkyl, C₁-C₁₆-alkenyl, C₁-C₁₆-alkoxy, C₁-C₁₆-alkenyloxy, C₃-C₁₀-cycloalkyl, C₃-C₁₀-cycloalkoxy, C₆-C₁₀-aryl, C₆-C₁₀-aryloxy, C₆-C₁₀-aryl-C₁-C₁₆-alkyl, C₆-C₁₀-aryl-C₁-C₁₆-alkoxy, NR²R³, COR², COOR², and CONR²R³, and the radicals X¹ and X², independently of one another, are O or S.

Another group of suitable oligophosphorus compounds is that having one of the following structures IIa, IIb, or IIc:

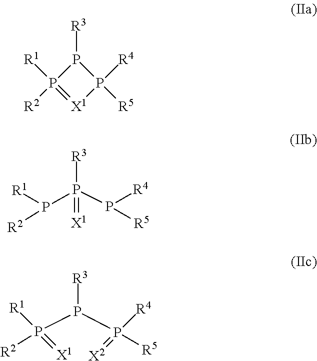

where the radicals R¹-R⁵ have been selected independently of one another from the group of C₁-C₁₆-alkyl, C₁-C₁₆-alkenyl, C₁-C₁₆-alkoxy, C₁-C₁₆-alkenyloxy, C₃-C₁₀-cycloalkyl, C₃-C₁₀-cycloalkoxy, C₆-C₁₀-aryl, C₆-C₁₀-aryloxy, C₆-C₁₀-aryl-C₁-C₁₆-alkyl, C₆-C₁₀-aryl-C₁-C₁₆-alkoxy, NR²R³, COR², COOR², and CONR²R³, and the radicals X¹ and X², independently of one another, are O or S.

Other suitable compounds are cyclic oligophosphorus compounds of the following structure III:

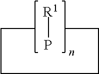

The radicals R¹ have been selected from the group of C₁-C₁₆-alkyl, C₁-C₁₆-alkenyl, C₁-C₁₆-alkoxy, C₁-C₁₆-alkenyloxy, C₃-C₁₀-cycloalkyl, C₃-C₁₀-cycloalkoxy, C₆-C₁₀-aryl, C₆-C₁₀-aryloxy, C₆-C₁₀-aryl-C₁-C₁₆-alkyl, C₆-C₁₀-aryl-C₁-C₁₆-alkoxy, NR²R³, COR², COOR², and CONR²R³, and n is a whole number from 2 to 6.

Particularly preferred flame retardants used are tetraphenyldiphosphine monoxide, tetraphenyldiphosphine monosulfide, tetraphenyldiphosphine dioxide, tetraphenyldiphosphine disulfide, tetraphenyldiphosphine oxide sulfide, pentaphenylpentaphospholane, 1,1,3,3-tetramethoxy-2-phenyltriphosphine 1,3-dioxide, 1,1,3,3-tetraethoxy-2-phenyltriphosphine 1,3-dioxide, 1,1,3,3-tetraallyloxy-2-phenyltriphosphine 1,3-dioxide, or a mixture thereof.

The halogen-free, flame-retardant polymer foams of the invention generally comprise an amount in the range from 0.5 to 25% by weight, based on the polymer foam, of the cyclic or acyclic oligophosphorus compounds. In particular in the case of foams composed of expandable polystyrene, amounts of from 5 to 15% by weight, based on the polymer foam, ensure adequate flame retardancy.

The effectiveness of the oligophosphorus compounds can be further improved via addition of suitable flame retardant synergists, an example being the thermal free-radical generator dicumyl peroxide, di-tert-butyl peroxide, or dicumyl. It is usual here to use from 0.05 to 5 parts by weight of the flame retardant synergist in addition to the oligophosphorus compound.

It is also possible to make additional use of further flame retardants, e.g. melamine, melamine cyanurates, metal oxides, metal hydroxides, phosphates, phosphinates, expandable graphite, or synergists, such as Sb₂O₃ or Zn compounds. Suitable additional halogen-free flame retardants are available commercially as Exolit OP 930, Exolit OP 1312, DOPO, HCA-HQ, M-Ester Cyagard RF-1241, Cyagard RF-1243, Fyrol PMP, AIPi, Melapur 200, Melapur MC, APP.

If the polymer foam does not have to be completely halogen-free, it is possible to produce reduced-halogen-content foams by using the oligophosphorus compound of the invention and adding relatively small amounts of halogen-containing, in particular brominated, flame retardants, such as hexabromocyclodecane (HBCD), preferably in amounts in the range from 0.05 to 1% by weight, in particular from 0.1 to 0.5% by weight.

The density of the halogen-free, flame-retardant polymer foams is preferably in the range from 5 to 200 kg/m³, particularly preferably in the range from 10 to 50 kg/m³, and it is preferable that more than 80%, particularly preferably from 95 to 100%, of the cells in the foam are closed cells.

The halogen-free, flame-retardant polymer foams preferably comprise a thermoplastic polymer, in particular a styrene polymer.

The expandable styrene polymers (EPS) of the invention, rendered flame-retardant by a halogen-free method, and the corresponding extruded styrene polymer foams (XPS) can be processed via mixing to incorporate a blowing agent and the oligophosphorus compound into the polymer melt and subsequent extrusion and pelletization under pressure to give expandable pellets (EPS), or via extrusion and depressurization, using appropriately shaped dies, to give foam sheets (XPS) or foam extrudates.

The molar mass M_{w} of the expandable styrene polymer is preferably in the range from 120 000 to 400 000 g/mol, particularly preferably in the range from 180 000 to 300 000 g/mol, measured by means of gel permeation chromatography with refractiometric detection (RI) against polystyrene standards. Because of molecular-weight degradation due to shear and/or exposure to heat, the molar mass of the expandable polystyrene is generally below the molar mass of the polystyrene used by about 10 000 g/mol.

Preferred styrene polymers used are glassclear polystyrene (GPPS), impact-resistant polystyrene (HIPS), anionically polymerized polystyrene or impact-resistant polystyrene (AIPS), styrene-α-methylstyrene copolymers, acrylonitrile-butadiene-styrene polymers (ABS), styrene-acrylonitrile (SAN), acrylonitrile-styrene-acrylate (ASA), methyl methacrylate-butadiene-styrene (MBS), and methyl methacrylate-acrylonitrile-butadiene-styrene (MABS) polymers, or a mixture thereof or a mixture with polyphenylene ether (PPE).

In order to improve mechanical properties or resistance to temperature change, the styrene polymers mentioned can be blended with thermoplastic polymers, such as polyamides (PA), polyolefins, such as polypropylene (PP) or polyethylene (PE), polyacrylates, such as polymethyl methacrylate (PMMA), polycarbonate (PC), polyesters, such as polyethylene terephthalate (PET) or polybutylene terephthalate (PBT), polyether sulfones (PES), polyether ketones, or polyether sulfides (PES), or a mixture thereof, generally in proportions of at most a total of 30% by weight, preferably in the range from 1 to 10% by weight, based on the polymer melt, optionally with use of compatibilizers. It is also possible to produce mixtures in the ranges of amounts mentioned with, for example, hydrophobically modified or functionalized polymers or oligomers, or rubbers, such as polyacrylates or polydienes, e.g. with styrene-butadiene block copolymers, or with biodegradable aliphatic or aliphatic/aromatic copolyesters.

Examples of suitable compatibilizers are maleic-anhydride-modified styrene copolymers, polymers containing epoxy groups, or organosilanes.

The styrene polymer melt can also receive admixtures of recycled polymers derived from the thermoplastic polymers mentioned, in particular styrene polymers and expandable styrene polymers (EPS), in amounts which do not substantially impair their properties, and generally in amounts of at most 50% by weight, in particular in amounts of from 1 to 20% by weight.

The styrene polymer melt comprising blowing agent generally comprises one or more blowing agents homogeneously distributed in a total proportion of from 2 to 10% by weight, preferably from 3 to 7% by weight, based on the styrene polymer melt comprising blowing agent. Suitable blowing agents are the physical blowing agents usually used in EPS, examples being aliphatic hydrocarbons having from 2 to 7 carbon atoms, alcohols, ketones, ethers, and halogenated hydrocarbons. Preference is given to the use of isobutane, n-butane, isopentane, or n-pentane. For XPS it is preferable to use CO₂ or a mixture with alcohols or with ketones.

To improve foamability, finely dispersed droplets of internal water may be introduced into the styrene polymer matrix. An example of a method for this is the addition of water to the molten styrene polymer matrix. The location of addition of the water may be upstream of, together with, or downstream of, the blowing agent feed. Dynamic or static mixers can be used to achieve homogeneous distribution of the water. An adequate amount is generally from 0 to 2% by weight of water, preferably from 0.05 to 1.5% by weight, based on the styrene polymer.

Expandable styrene polymers (EPS) with at least 90% of the internal water in the form of droplets of internal water with diameter in the range from 0.5 to 15 pm form, on foaming, foams with an adequate number of cells and with homogeneous foam structure.

The amount added of blowing agent and of water is selected in such a way that the expansion capability a of the expandable styrene polymers (EPS), defined as bulk density prior to foaming/bulk density after foaming, is at most 125, preferably from 25 to 100.

The bulk density of the expandable styrene polymer pellets (EPS) of the invention is generally at most 700 g/l, preferably in the range from 590 to 660 g/l. If fillers are used, bulk densities in the range from 590 to 1200 g/l may arise, depending on the nature and amount of the filler.

The styrene polymer melt can also receive additions of additives, nucleating agents, fillers, plasticizers, soluble and insoluble inorganic and/or organic dyes and pigments, e.g. IR absorbers, such as carbon black, graphite, or aluminum powder, together or with spatial separation, e.g. by way of mixers or ancillary extruders. The amounts generally added of the dyes and pigments are in the range from 0.01 to 30% by weight, preferably in the range from 1 to 5% by weight. For homogeneous and microdisperse distribution of the pigments within the styrene polymer, it can be advantageous, particularly in the case of polar pigments, to use a dispersing agent, e.g. organosilanes, polymers containing epoxy groups, or maleic anhydride-grafted styrene polymers.

Preferred plasticizers are mineral oils and phthalates, and the amounts used of these may be from 0.05 to 10% by weight, based on the styrene polymer.

To produce the expandable styrene polymers of the invention, mixing can be used to incorporate the blowing agent into the polymer melt. One possible process comprises the stages of a) production of a melt, b) mixing, c) cooling, d) conveying, and e) pelletization. Each of these stages can be executed by using the apparatuses or apparatus combinations known in plastics processing. Static or dynamic mixers can be used for the mixing process to incorporate the material, examples being extruders. The polymer melt can be removed directly from a polymerization reactor or can be produced directly in the mixing extruder or in a separate compounding extruder, via melting of polymer pellets. The melt can be cooled in the mixing assemblies or in separate coolers. Examples of possible methods of pelletization are pressurized underwater pelletization, pelletization by rotating knives, and cooling via spray misting of temperature-control liquids, or pelletizing with atomization. Examples of suitable arrangements of apparatus for carrying out the process are:

a) polymerization reactor-static mixer/cooler-pelletizer

b) polymerization reactor-extruder-pelletizer

c) extruder-static mixer-pelletizer

d) extruder-pelletizer

The arrangement may also have ancillary extruders for introducing additives, e.g. solids or heat-sensitive additives.

The temperature of the styrene polymer melt comprising blowing agent when it is passed through the die plate is generally in the range from 140 to 300° C., preferably in the range from 160 to 240° C. Cooling to the region of the glass transition temperature is not necessary.

The die plate is heated at least to the temperature of the polystyrene melt comprising blowing agent. The temperature of the die plate is preferably above the temperature of the polystyrene melt comprising blowing agent, by from 20 to 100° C., in order to avoid polymer deposits in the dies, and to ensure problem-free pelletization.

In order to obtain marketable pellet sizes, the diameter (D) of the holes in the die at the outlet of the die should be in the range from 0.2 to 1.5 mm, preferably in the range from 0.3 to 1.2 mm, particularly preferably in the range from 0.3 to 0.8 mm. This permits targeted adjustment to pellet sizes below 2 mm, in particular in the range from 0.4 to 1.4 mm, even after die swell.

Particular preference is given to a process for the production of expandable styrene polymers (EPS) rendered flame-retardant by a halogen-free method, comprising the steps of
a) mixing to incorporate an organic blowing agent and from 1-25% by weight of cyclic or acyclic oligophosphorus compound of the invention into the polymer melt by means of a static or dynamic mixer at a temperature of at least 150° C.,
b) cooling of the styrene polymer melt comprising blowing agent, to a temperature which is 120° C. or higher,
c) discharge via a die plate with holes, the diameter of which at the die outlet is at most 1.5 mm, and
d) pelletizing of the melt comprising blowing agent, directly downstream of the die plate, under water, at a pressure in the range from 1 to 20 bar.

It is also possible to produce the expandable styrene polymers (EPS) of the invention via suspension polymerization.

In the suspension polymerization process, it is preferable to use styrene alone as monomer. However, up to 20% of its weight can have been replaced by other ethylenically unsaturated monomers, such as alkylstyrenes, divinylbenzene, acrylonitrile, 1,1-diphenyl ether or α-methylstyrene.

The usual auxiliaries can be added during the suspension polymerization process, examples being peroxide initiators, suspension stabilizers, blowing agents, chain-transfer agents, expansion aids, nucleating agents, and plasticizers. The amounts of the cyclic or acyclic oligophosphorus compound of the invention added in the polymerization process are from 0.5 to 25% by weight, preferably from 5 to 15% by weight. The amounts of blowing agents added are from 3 to 10% by weight, based on monomer. These amounts can be added prior to, during, or after polymerization of the suspension. Suitable blowing agents are aliphatic hydrocarbons having from 4 to 6 carbon atoms. It is advantageous to use inorganic Pickering dispersants as suspension stabilizers, an example being magnesium pyrophosphate or calcium phosphate.

The suspension polymerization process produces bead-shaped particles which are in essence round, with average diameter in the range from 0.2 to 2 mm.

In order to improve processability, the finished expandable styrene polymer pellets can be coated with glycerol ester, antistatic agent, or anticaking agent.

The EPS pellets can be coated with glycerol monostearate GMS (typically 0.25%), glycerol tristearate (typically 0.25%), Aerosil R972 fine-particle silica (typically 0.12%), or Zn stearate (typically 0.15%), or else antistatic agent.

The expandable styrene polymer pellets of the invention can be prefoamed in a first step by means of hot air or steam to give foam beads with density in the range from 8 to 200 kg/m³, in particular from 10 to 50 kg/m³, and can be fused in a 2^{nd} step in a closed mold, to give molded foams.

The expandable polystyrene particles can be processed to give polystyrene foams with densities of from 8 to 200 kg/m³, preferably from 10 to 50 kg/m³. To this end, the expandable beads are prefoamed. This is mostly achieved by heating of the beads, using steam in what are known as prefoamers. The resultant prefoamed beads are then fused to give moldings. To this end, the prefoamed beads are introduced into molds which do not have a gas-tight seal, and are treated with steam. The moldings can be removed after cooling.

### EXAMPLES

Flame Retardants FR 1-FR 10 Used

Diphosphines

| | | |
|---|---|---|
| 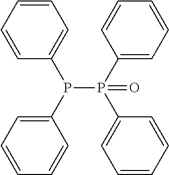 | Tetraphenyl- diphosphine monoxide | FR1 |
| 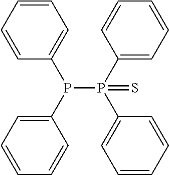 | Tetraphenyl- diphosphine sulfide | FR2 |
| 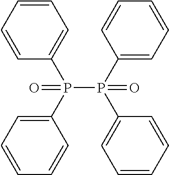 | Tetraphenyl- diphosphine dioxide | FR3 |
| 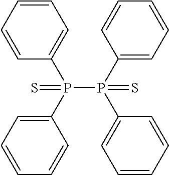 | Tetraphenyl- diphosphine disulfide | FR4 |
| 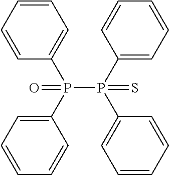 | Tetraphenyl- diphosphine oxide sulfide | FR5 |

Cyclic oligophosphines

| | | |
|---|---|---|
| 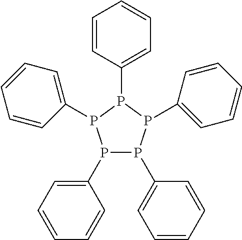 | Pentaphenylpenta- phospholane | FR6 |

Triphosphines

| | | |
|---|---|---|
| 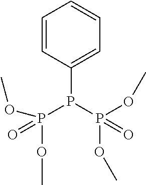 | 1,1,3,3-Tetra- methoxy-2- phenyltriphosphine 1,3-dioxide | FR7 |
| 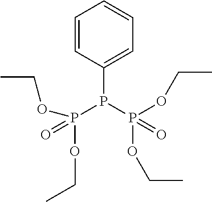 | 1,1,3,3-Tetra- ethoxy-2- phenyltriphosphine 1,3-dioxide | FR8 |
| 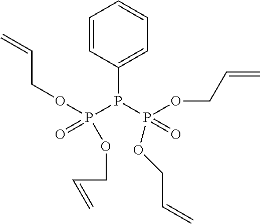 | 1,1,3,3-Tetra- allyloxy-2- phenyltriphosphine 1,3-dioxide | FR9 |

The organic phosphorus compounds FR 1 to FR 9 used as flame retardants in the examples were synthesized in accordance with the preparation specifications below:

Tetraphenyldiphosphine dioxide and tetraphenyldiphosphine disulfide starting from tetraphenyldiphosphine: (by the method of: W. Kuchen, H. Buchwald, Chem. Ber., 1958, 91, 2871-2877.)

### Tetraphenyldiphosphine

A solution of 6 g (0.0325 mol) of diphenylphosphine and 7.1 g (0.0325 mol) of diphenylchlorophosphine in 100 ccm of ligroin (boiling point from 90 to 100° C., distilled over sodium) was heated for 3.5 hours in a stream of nitrogen with stirring and at reflux. This gave vigorous evolution of hydrogen chloride. Cooling with constant stirring gave a precipitate of tetraphenyldiphosphine in the form of a white, finely crystalline powder, which was isolated by suction filtration with exclusion of air, washed repeatedly with ligroin, dried under high vacuum, and stored under nitrogen. Melting point (in evacuated tube) 120.5° C.; boiling point 1 from 258 to 260° C. Sparingly soluble in benzene, toluene, carbon tetrachloride, and pyridine (with yellow color), and very sparingly soluble in ether, ethanol, and ligroin. Yield about 80% of theory. C₂₄H₂₀P₂ (370.4); calc. P 16.73, found P 16.62; molecular weight 391.6, 374.9 (RAST method)

### Tetraphenyldiphosphine Dioxide

A thoroughly dried stream of air was passed for 3 hours into a suspension of 3.3 g of tetraphenyldiphosphine in 30 ccm of absol. toluene, with ice cooling. The liquid phase, initially colorless, became yellowish during this process. After said period, the mixture was briefly heated to boiling and further toluene (about 30 ccm) was added until all of the material had been dissolved. Fine, white crystals precipitated from the clear solution on cooling, and, after repeated crystallization from toluene in an evacuated test tube, had a sharp melting point at 167° C. Yield 1.9 g (53% of theory). C₂₄H₂₀O₂P₂ (402.4) calc. P 15.40, found P 15.38 molecular weight 418.5, 409.8 (RAST method)

### Tetraphenyldiphosphine Disulfide

10.8 g of tetraphenyldiphosphine and 1.9 g of sulfur were heated at reflux for 8 hours in carbon disulfide, under nitrogen. Colorless needles precipitated from the clear solution on cooling and, after recrystallization from ethanol/water, had a melting point of 168.5° C. Yield 4.2 g. A further 1.2 g of the compound were obtained by concentrating the carbon disulfide solution and repeatedly recrystallizing the crystalline product that precipitated during this process. Total yield 5.4 g (42.4% of theory). The product is soluble in chloroform, benzene, toluene, dioxane, and ether, and does not undergo any noticeable alteration even when heated with dilute sodium hydroxide solution. C₂₄H₂₀P₂S₂ (434.5) calc. P 14.26, S 14.75 found P 14.29, S 14.78 molecular weight 419.1, 427.6 (RAST method)

### Tetraphenyldiphosphine Monooxide

(By the Method of: E. Fluck, H. Binder, Inorg. Nucl. Chem. Letters, 1967, 3, 307-313.)

22 g (0.1 mol) of diphenylphosphine chloride are heated at reflux for 2 hours with 21.6 g (0.1 mol) of methyl diphenylphosphinite in 100 ml of absolute benzene in a gentle stream of nitrogen. The benzene is then removed by distillation on a rotary evaporator. This gives tetraphenyldiphosphine monoxide in the form of colorless crystals, which can be recrystallized from a little benzene. Yield: 37 g, i.e. 93.5% of theory, freezing point from 158-161° C. (in vacuo); analysis: C₂₄H₂₀P₂O calc. C: 74.61%; H: 5.22%; P: 16.03%; 0 4.14% found C: 74.01% H: 5.42% P: 15.56%

### Tetraphenyldiphosphine Monosulfide

(By the Method of: H. Matschiner, F. Krech, A. Steinert, Z. Anorg. Allg. Chem., 1969, 371, 256-262.)

5 g of tetraphenyldiphosphine are dissolved in 50 ml of carbon disulfide and reacted with 0.43 g of sulfur. After removal of the solvent by distillation, the residue is repeatedly recrystallized from gasoline (boiling point 115° C.). Freezing point 138° C.; yield 1.2 g (22% of theory). C₂₄H₂₀P₂S (402.4); calc. P 15.39% (found 15.15%); calc. S 7.97% (found 7.91%).

### 1,1,3,3-Tetraallyloxy-2-phenyltriphosphine 1,3-dioxide

This compound was synthesized as follows:

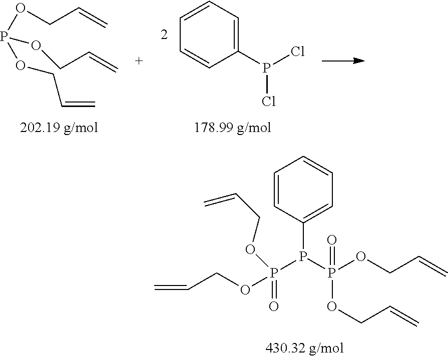

Mixture:

| | | | | |
|---|---|---|---|---|
| 44.7 | g | 0.25 | mol | of dichlorophenylphosphine |
| 101.1 | g | 0.5 | mol | of triallyl phosphite |
| 100 | ml | | | of acetonitrile |

Experimental Method:

Dichlorophenylphosphine and acetonitrile form an initial charge in the flask, with stirring. Triallyl phosphite is added dropwise within a period of 52 minutes at from 22 to 36° C. The mixture is heated to about 68° C. and stirred for 1.5 h. ³¹P NMR on the reaction solution shows almost complete conversion. Stirring is continued for a further 4 h on the following day, at about 68° C. (gentle reflux). Solvent is removed on a rotary evaporator. The mixture is then dried for 4 h at 80° C. under oil-pump vacuum at 0.1 mbar.

Crude yield: 92.54 g (86%), purity (NMR): 60%

³¹P NMR (toluene_{d8}), [ppm]: 28.9 (d, ¹J_{P,P}=165 Hz), −59.9 (t, ¹J_{P,P}=164 Hz).

### 1,1,3,3-Tetramethoxy-2-phenyltriphosphine 1,3-dioxide

By analogy with K. M. Abraham, J. R. v. Wazer, Inorg. Chem. 1976, 15, 9, 2322-2323, synthesized by the method of Demik, N. N.; Kabachnik, M. M.; Novikova, Z. S.; Beletskaya, I. P.; J. Gen. Chem. USSR (Engl. Transl.); English; 61; 2; 1991; 460 -461; Zhurnal Obshchei Khimii; Russian; 61; 2; 1991; 506-507.

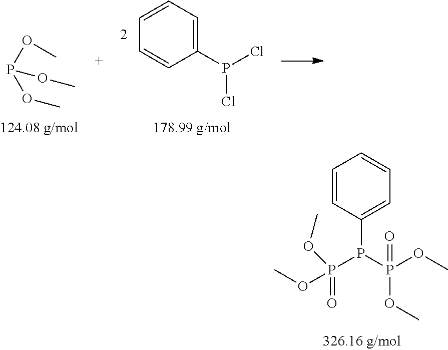

Mixture:

| | | | | |
|---|---|---|---|---|
| 44.7 | g | 0.25 | mol | of dichlorophenylphosphine |
| 62.04 | g | 0.5 | mol | of trimethyl phosphite |
| 100 | ml | | | of toluene |

Experimental Method:

Phosphine, phosphite, and toluene were provided as initial charge, in the flask, with stirring, and heated within a period of 0.5 h to 113° C. (bath temperature 120° C.). The mixture was stirred at this temperature for 6 h, with slight visible gas evolution. No further gas evolution was then visible.

³¹P NMR of the reaction solution shows complete conversion.

The reaction mixture was concentrated on a rotary evaporator. The residue has a very unpleasant odor of trimethyl phosphite. MTB ether was admixed with this, and again the mixture was concentrated by evaporation. The residue was dried for 5 h at 60° C. in vacuo on an oil pump (0.1 mbar). Crude yield: 67.66 g (83%), purity (NMR): 78%.

### 1,1,3,3-Tetraethoxy-2-phenyltriphosphine 1,3-dioxide

Prepared by the method of Demik, N. N.; Kabachnik, M. M.; Novikova, Z. S.; Beletskaya, I. P.; J. Gen. Chem. USSR (Engl. Transl.); English; 61; 2; 1991; 460-461; Zhurnal Obshchei Khimii; Russian; 61; 2; 1991; 506-507.

A mixture of 0.05 mol of phenylphosphorus dichloride, 0.1 mol of triethyl phosphite, and 5 mol % of anhydrous nickel chloride was heated at 150° C. for 30 minutes under dry argon. The reaction mixture was fractionated. The yield was 94%, boiling point 99° C. (0.2 mm).

Pentaphenylcyclopentaphosphine:

(by the method of: W. A. Henderson, M. Epstein, F. S. Seichter, J. Am. Chem. Soc., 1963, 85, 2462-2466.)

Phenyldichlorophosphine (8.9 g, 0.05 mol) was added, with stirring, to 1.2 g (0.05 mol) of magnesium shavings in 50 ml of tetrahydrofuran as solvent. The reaction was highly exothermic and required a condenser, slow addition of the phenyldichlorophosphine, and periods of external water-bath cooling. Once most of the phosphine had been added, salt began to precipitate. Addition was complete after 30 minutes. After some hours, only traces of metal remained. The salt was dissolved by adding a small amount of acetone, and magnesium was removed by filtration. Addition of 30 ml formed a two-phase system with an organic layer and an aqueous layer comprising salt. Addition of a second portion of water to the organic layer gave a precipitate of 4.0 g (84%) of tetraphenylcyclotetraphosphines with melting point from 148 to 152° C.

### Inventive Examples 1 to 10

### Expandable Polystyrene (EPS)

7 parts by weight of n-pentane were incorporated by mixing into a polystyrene melt made of PS 148G from BASF SE with intrinsic viscosity IV of 83 ml/g. After the melt comprising blowing agent had been cooled from initially 260° C. to a temperature of 190° C., a polystyrene melt which comprised the flame retardants specified in the table was incorporated by mixing into the main stream, by way of an ancillary extruder. The stated amounts in parts by weight are based on the entire amount of polystyrene.

The mixture of polystyrene melt, blowing agent, and flame retardant was conveyed at 60 kg/h through a die plate with 32 holes (diameter of dies 0.75 mm). Compact pellets with narrow size distribution were produced with the aid of pressurized underwater pelletization.

The pellets were prefoamed by exposure to flowing steam and, after storage for 12 hours, fused by further treatment with steam in a closed mold to give foam blocks of density 15 kg/m³.

The fire behavior of the foam sheets was determined after storage for 72 hours, with foam density of 15 kg/m³ to DIN 4102. Table 1 collates the nature and amount of the flame retardant used, and the extinguishment times. Inventive examples 1 to 10 and comparative example comp 1 passed the B2 fire test.

### Comparative Examples comp1-comp3

By analogy with inventive examples 1 to 3, expandable polystyrene was produced with flame retardants:

comp1 hexabromocyclododecane (HBCD)

comp2 9,14-dihydro-9-oxa-10-phosphaphenanthrene 10-oxide (DOP) (according to WO 2006/027241)

comp3 no flame retardant

TABLE 1
Fire test on inventive examples 1-10 and
comparative examples comp 1-comp3

| | | Amount of flame | Extinguishment time [s] | |
|---|---|---|---|---|
| | Flame | retardant in % by weight, | in B2 fire test | |
| Example | retardant | based on polystyrene | (DIN 4102) | |
| comp1 | HBCD | 4 | 6.4 | s |
| 1 | FR 1 | 8 | 7.1 | |
| 2 | FR 2 | 8 | 5.8 | |
| 3 | FR 3 | 8 | 6.9 | |
| 4 | FR 4 | 8 | 5.1 | |
| 5 | FR 5 | 8 | 7.9 | |
| 6 | FR 6 | 8 | 5.4 | |
| 7 | FR 7 | 8 | 7.9 | |
| 8 | FR 8 | 8 | 5.9 | |
| 9 | FR 9 | 8 | 8.1 | |
| 10 | FR 10 | 8 | 5.6 | |
| comp2 | DOP | 8 | 20 | s, n. P. |

| | | |
|---|---|---|
| comp3 | — | total combustion, n. P. |

n. P.: B2 fire test not passed

### Inventive Examples 11-15

### Extruded Polystyrene Foam Sheets (XPS)

100 parts by weight of 158K polystyrene from BASF SE with intrinsic viscosity of 98 ml/g, 0.1 part of talc as nucleating agent for cell size regulation, and the number of parts stated in the table of flame retardants, and also optionally flame retardant synergist (e.g. 2,3-diphenyl-2,4-dimethylbutane) were continuously introduced into an extruder with internal screw diameter of 120 mm. A blowing agent mixture made of 3.25 parts by weight of ethanol and 3.5 parts by weight of CO₂ is injected continuously and simultaneously through an inlet aperture provided in the extruder. The gel, uniformly kneaded at 180° C. in the extruder, is passed through a relaxation zone and, after a residence time of 15 minutes, extruded into the atmosphere with an outlet temperature of 105° C. through a die of breadth 300 mm and width 1.5 mm. The foam is passed through a molding channel connected to the extruder, to produce a foamed strip of sheet with cross section 650 mm×50 mm and density of 35 g/l. The product was cut into sheets. The fire behavior of the specimens was tested after 30 days of storage time, to DIN 4102.

Table 2 collates the nature and amount of the flame retardant used, and the extinguishment times. Inventive examples 11-15 and comparative example comp4 passed the B2 fire test.

TABLE 2
Fire test on inventive examples 11-15

| | | Amount of flame | Extinguishment time [s] |
|---|---|---|---|
| | Flame | retardant in % by weight, | in B2 fire test |
| Example | retardant | based on polystyrene | (DIN 4102) |
| comp4 | HBCD | 4 | 9.4 s |
| 11 | FR 1 | 8 | 7.9 |
| 12 | FR 2 | 8 | 9.8 |
| 13 | FR 3 | 8 | 8.9 |
| 14 | FR 4 | 8 | 9.1 |
| 15 | FR 4 | 6 + 0.2 part of 2,3-diphenyl- | 7.1 |
| | | 2,4-dimethylbutane | |

1-13. (canceled)

14. A halogen-free, flame-retardant polymer foam which comprises, as flame retardant, at least one acyclic oligophosphorus compound selected from acyclic oligophosphine chalcogenides having from 2 to 6 phosphorus atoms and having at least one phosphorus-phosphorus bond.

15. The halogen-free, flame-retardant polymer foam according to claim 14, wherein the oligophosphorus compound has one of the following structures, Ia or Ib 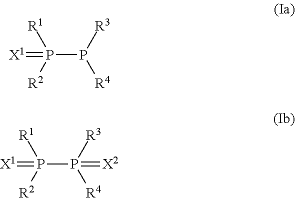
where the radicals R¹-R⁴, independently of one another, have been selected from the group consisting of C₁-C₁₆-alkyl, C₁-C₁₆-alkenyl, C₁-C₁₆-alkoxy, C₁-C₁₆-alkenyloxy, C₃-C₁₀-cycloalkyl, C₃-C₁₀-cycloalkoxy, C₆-C₁₀-aryl, C₆-C₁₀-aryloxy, C₆-C₁₀-aryl-C₁-C₁₆-alkyl, C₆C₁₀-aryl-C₁-C₁₆-alkoxy, NR²R³, COR², COOR², and CONR²R³, and the radicals X¹ and X², independently of one another, are O or S.

16. The halogen-free, flame-retardant polymer foam according to claim 14, wherein the oligophosphorus compound has one of the following structures IIa, IIb, or IIc 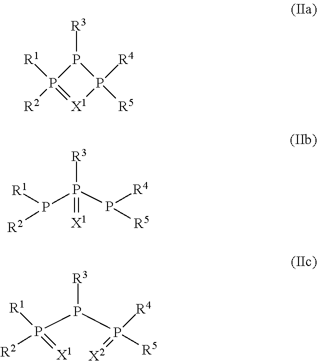
where the radicals R¹-R⁵, independently of one another, have been selected from the group consisting of C₁-C₁₆-alkyl, C₁-C₁₆-alkenyl, C₁-C₁₆-alkoxy, C₁-C₁₆-alkenyloxy, C₃-C₁₀-cycloalkyl, C₃-C₁₀-cycloalkoxy, C₆-C₁₀-aryl, C₆-C₁₀-aryloxy, C₆-C₁₀-aryl-C₁-C₁₆-alkyl, C₆-C₁₀-aryl-C₁-C₁₆-alkoxy, NR²R³, COR², COOR², and CONR²R³, and the radicals X′ and X², independently of one another, are O or S.

17. The halogen-free, flame-retardant polymer foam according to claim 14, which comprises, as flame retardant, tetraphenyldiphosphine monoxide, tetraphenyldiphosphine monosulfide, tetraphenyldiphosphine dioxide, tetraphenyldiphosphine disulfide, tetraphenyldiphosphine oxide sulfide, pentaphenylpentaphospholane, 1,1,3,3-tetramethoxy-2-phenyltriphosphine 1,3-dioxide, 1,1,3,3-tetraethoxy-2-phenyltriphosphine 1,3-dioxide, 1,1,3,3-tetraallyloxy-2-phenyltriphosphine 1,3-dioxide, or a mixture thereof.

18. The halogen-free, flame-retardant polymer foam according to claim 14, which comprises an amount in the range from 0.5 to 25% by weight, based on the polymer foam, of the acyclic oligophosphorus compounds.

19. The halogen-free, flame-retardant polymer foam according to claim 14, which has a density in the range from 5 to 200 kg/m³.

20. The halogen-free, flame-retardant polymer foam according to claim 14, wherein more than 80% of the cells are closed cells.

21. The halogen-free, flame-retardant polymer foam according to claim 14, wherein the polymer is a styrene polymer.

22. A process for the production of expandable styrene polymers (EPS) rendered flame-retardant by a halogen-free method, or of flame-retardant extruded styrene polymer foams (XPS), which comprises using, as flame retardant, the acyclic oligophosphorus compound according to claim 14.

23. A process for the production of expandable styrene polymers (EPS) rendered flame-retardant by a halogen-free method, comprising the steps of
a) mixing to incorporate an organic blowing agent and from 1-25% by weight of the acyclic oligophosphorus compound according to claim 14 into a styrene polymer melt by means of a static or dynamic mixer at a temperature of at least 150° C.,
b) cooling of the styrene polymer melt comprising blowing agent, to a temperature of at least 120° C.,
c) discharge via a die plate with holes, the diameter of which at the die outlet is at most 1.5 mm, and
d) pelletizing of the melt comprising blowing agent, directly downstream of the die plate, under water, at a pressure in the range from 1 to 20 bar.

24. A process for the production of expandable styrene polymers (EPS) rendered flame-retardant by a halogen-free method, via polymerization of styrene in aqueous suspension in the presence of an organic blowing agent and of a flame retardant, which comprises using, as flame retardant, the acyclic oligophosphorus compound according to claim 14.

25. An expandable styrene polymer (EPS) rendered flame-retardant by a halogen-free method, and obtainable according to claim 22.

26. A process for the production of molded polystyrene foams rendered flame-retardant by a halogen-free method, which comprises, in a first step, prefoaming expandable styrene polymers according to claim 21 by means of hot air or steam to give foam beads with density in the range from 8 to 200 g/l, and, in a 2^{nd} step, fusing these in a closed mold.
